(19) United States
(12) Patent Application Publication
(10) Pub. No.: US 2021/0209461 A1
(43) Pub. Date: Jul. 8, 2021

(54) METHODS FOR NEURAL NETWORK SPARSITY CHANNEL GENERATION AND INFERENCE

(71) Applicant: Baidu USA LLC, Sunnyvale, CA (US)

(72) Inventor: MIN GUO, San Diego, CA (US)

(21) Appl. No.: 16/734,268

(22) Filed: Jan. 3, 2020

(51) Int. Cl. G06N 3/08; G06N 5/04; G06N 3/04

(52) U.S. Cl. CPC G06N 3/08; H04L 67/12; G06N 3/04; G06N 5/04

(57) ABSTRACT

Methods are disclosed for accelerating inference operations of neural network (NN) models that take advantage of sparse channels. An offline method consolidates sparse channels for a layer into one consolidated sparse channel by concatenating the channel kernels associated with the sparse channels into one channel kernel. The method retrains the channel kernel of the consolidated sparse channel while keeping fixed the channel kernels for the dense channels to modify the channel model. The sparsity level of the retrained channel kernel of the consolidated sparse channel may be determined and stored in metadata. When the modified channel model is online, a method may compare the sparsity level of the retrained channel kernel of the consolidated sparse channel against a sparsity inference threshold to determine whether to inference the consolidated sparse channel. The sparsity inference threshold may be dynamically adjusted to strike a balance between speed and accuracy of the NN model.

### TECHNICAL FIELD

Embodiments of the present disclosure relate generally to machine learning. More particularly, embodiments of the disclosure relate to the generation and use of software models for inference by machine learning engines or neural networks in artificial intelligence applications.

### BACKGROUND

Neural networks are used in applications such as computer vision, natural language processing, robotics, and autonomous driving vehicles (ADVs). For example, neural networks may operate vehicles in an autonomous mode (e.g., driverless) to relieve occupants, especially the driver, from some driving-related responsibilities. When operating in an autonomous mode, a vehicle can navigate to various locations using onboard sensors, allowing the vehicle to travel with minimal human interaction or in some cases without any passengers. Neural networks may generate commands to plan and control the motion of the vehicles by processing video and electromagnetic images of environments around the vehicles captured by the onboard sensors. For example, neural networks may generate or train a set of rules, algorithms, and/or predictive models for perception, prediction, decision, planning, and/or control processes in the autonomous mode.

The accuracy and efficiency of the motion planning and control operations depends heavily on models used by the neural networks. Models in neural networks may process input channel data such as the sensor-captured video and electromagnetic images through one or more layers using matrices, or more generally multi-dimensional tensors, to derive a feature map output. Each layer of a neural network model may compute a representation of the input channel data from a previous layer to inference one or more output channels using the matrices corresponding to the output channels, also referred to as channel matrices or channel kernels, of the layer. The density, or conversely the sparsity level, of a matrix may be a measure of the number of zero or near-zero parameters of the matrix. The sparsity level may affect the speed of the inference computation as the multiplication and addition operations associated with zero or near-zero parameters may be skipped when performing matrix multiplications.

Most neural network models are designed for dense matrices. To accelerate the inference operation, neural network accelerators may exploit the sparsity level of the matrices in the models. For example, neural network accelerators may prune sparse channels whose corresponding channel matrices have a high number of zero or near-zero parameters by only performing inference operations for dense channels. However, such pruning algorithm may reduce the accuracy of the output feature map after quantization and inference operations, especially when propagating the errors through multiple layers. The selection of the channels to prune may also be rigid.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an architecture of an autonomous driving system operating according to one embodiment.

FIGS. 3 is an architecture of a neural network core in a host computing system in which neural network models are downloaded into a SRAM of the neural network core from external memories according to one embodiment.

FIG. 4 shows a model of a neural network with multiple inference layers and the channel kernels for the inference layers according to one embodiment.

FIG. 5 illustrates an offline method of rearranging the channels for a layer according to the sparsity levels of the channel kernels and consolidating the sparse channels into one channel by concatenating the associated channel kernels when generating the neural network model according to one embodiment.

FIG. 6 illustrates an arrangement of the channels for multiple inference layers of a retrained neural network model after the sparse channels for each layer are consolidated into one channel according to one embodiment of the offline model generation method.

FIG. 7 is a flowchart illustrating a method for offline training and generation of a neural network model that consolidates the sparse channels for a layer into one channel according to one embodiment.

FIG. 8 is a flowchart illustrating a method of controlling online inference operations based on sparsity metrics of the channel kernels of the neural network model that includes a consolidated sparse channel according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a method is disclosed for generating neural network models that take advantage of the sparse channels to accelerate inference operations. Neural network models perform inference operations for a layer by multiplying layer inputs with channel kernels to generate output channels. The sparsity levels of the channel kernels indicate the number of zeros or near-zero parameters of the matrices or tensors constituting the channel kernels. Channels whose channel kernels have a high number of zeros or near-zero parameters, e.g., low sparsity level, may be referred to as sparse channels. Sparse channels carry less weight when used to inference subsequent layers compared with dense channel. To de-emphasizes the sparse channels, the method may evaluate the sparsity levels of the channel kernels of an original channel model to consolidate the sparse channels for one or more layers and to retrain the channel model based on the consolidated channels to generate a modified channel model.

The method may consolidate sparse channels for a layer into one sparse channel by consolidating the channel kernels associated with the sparse channels into one channel kernel. Consolidation of sparse channels may be performed for every layer or for the first few layers of the neural network model. In one embodiment, the method may rearrange the channels in accordance with the sparsity levels of their corresponding channel kernels to group together the channels that have not been consolidated, i.e., the dense channels. The method may retrain the channel kernel of the consolidated sparse channel of the neural network model while keeping fixed the channel kernels for the dense channels to generate a modified channel model. After the retraining, the sparsity level of the retrained channel kernel of the consolidated sparse channel may change. The method may evaluate the sparsity level of the retrained channel kernel of the consolidated sparse channel to store the sparsity level as metadata.

According to some embodiments, a method is disclosed for controlling inference operations based on the sparsity levels of the channel kernels of a neural network model that includes a consolidated sparse channel. The method may compare the sparsity level of the channel kernel of the consolidated sparse channel of a layer read from metadata against a sparsity inference threshold to determine whether to inference the consolidated sparse channel. If the sparsity level associated with the consolidated sparse channel is above the sparsity inference threshold, the method may inference the consolidated sparse channel. Otherwise, the method does not inference the consolidated sparse channel. In one embodiment, the sparsity inference threshold may be dynamically adjusted to strike a balance between speed and accuracy of the inference operations of the neural network model.

While the description that follows illustrates methods for generating and inferencing neural network models for use in autonomous driving vehicles (ADVs), it is understood that the methods may also be applied to neural network models used in other applications.

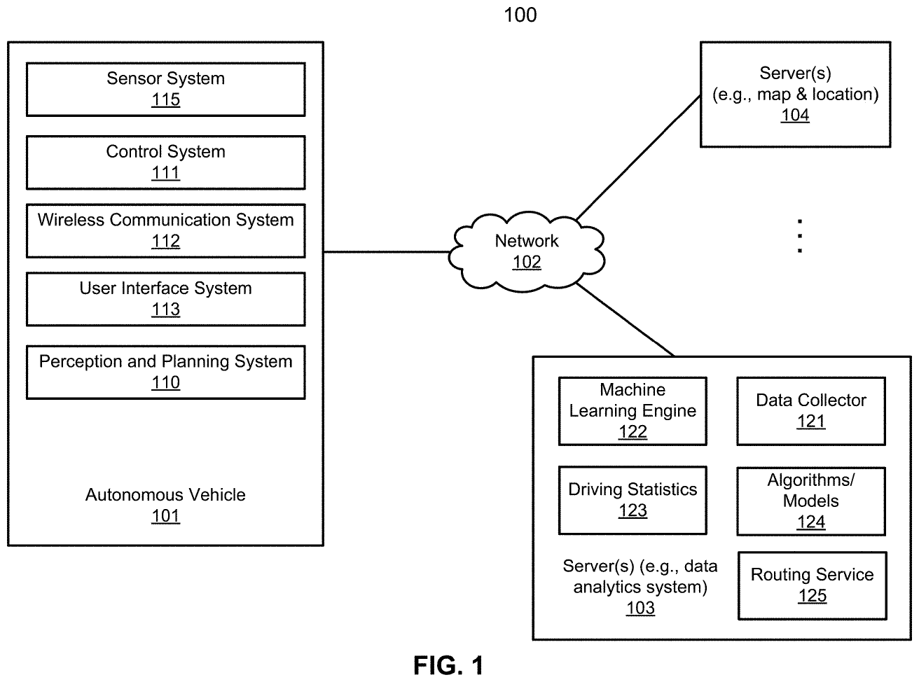

FIG. 1 is a block diagram illustrating an autonomous vehicle network configuration according to one embodiment of the disclosure. Referring to FIG. 1, network configuration 100 includes autonomous vehicle 101 that may be communicatively coupled to one or more servers 103-104 over a network 102. Although there is one autonomous vehicle shown, multiple autonomous vehicles can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) severs, or location servers, etc.

An autonomous vehicle refers to a vehicle that can be configured in an autonomous mode in which the vehicle navigates through an environment with little or no input from a driver. Such an autonomous vehicle can include a sensor system having one or more sensors that are configured to detect information about the environment in which the vehicle operates. The vehicle and its associated controller(s) use the detected information to navigate through the environment. Autonomous vehicle 101 can operate in a manual mode, a full autonomous mode, or a partial autonomous mode.

In one embodiment, autonomous vehicle 101 includes, but is not limited to, perception and planning system 110, vehicle control system 111, wireless communication system 112, user interface system 113, and sensor system 115. Autonomous vehicle 101 may further include certain common components included in ordinary vehicles, such as, an engine, wheels, steering wheel, transmission, etc., which may be controlled by vehicle control system 111 and/or perception and planning system 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

Wireless communication system 112 is configured to allow communication between autonomous vehicle 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyword, a touch screen display, a microphone, and a speaker, etc.

Some or all of the functions of autonomous vehicle 101 may be controlled or managed by perception and planning system 110, especially when operating in an autonomous driving mode. Perception and planning system 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, perception and planning system 110 may be integrated with vehicle control system 111.

For example, a user as a passenger may specify a starting location and a destination of a trip, for example, via a user interface. Perception and planning system 110 obtains the trip related data. For example, perception and planning system 110 may obtain location and route information from an MPOI server, which may be a part of servers 103-104. The location server provides location services and the MPOI server provides map services and the POIs of certain locations. Alternatively, such location and MPOI information may be cached locally in a persistent storage device of perception and planning system 110.

While autonomous vehicle 101 is moving along the route, perception and planning system 110 may also obtain real-time traffic information from a traffic information system or server (TIS). Note that servers 103-104 may be operated by a third party entity. Alternatively, the functionalities of servers 103-104 may be integrated with perception and planning system 110. Based on the real-time traffic information, MPOI information, and location information, as well as real-time local environment data detected or sensed by sensor system 115 (e.g., obstacles, objects, nearby vehicles), perception and planning system 110 can plan an optimal route and drive vehicle 101, for example, via control system 111, according to the planned route to reach the specified destination safely and efficiently.

Server 103 may be a data analytics system to perform data analytics services for autonomous vehicle 101 or a variety of clients. In one embodiment, data analytics system 103 includes data collector 121 and machine learning engine 122. Data collector 121 collects driving statistics 123 from autonomous vehicle 101, or from a variety of vehicles driven autonomously or by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. In one embodiment, algorithms 124 may include models, rules or algorithms for perception, prediction, decision, planning, and/or control processes. Algorithms and models 124 can then be uploaded on ADVs to be utilized during autonomous driving in real-time. For example, control system 111 or perception and planning system 110 may be neural networks that use the algorithms and models 124 and real-time local environment data sensed by sensor system 115 to perceive obstacles, predict motions of other vehicles, and plan and control the motion of autonomous vehicle 101.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

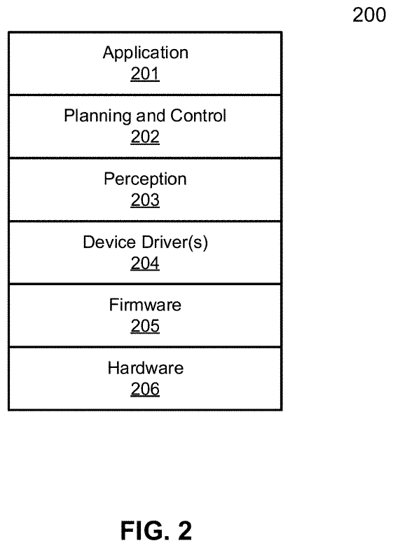

FIG. 2 is a block diagram illustrating system architecture for autonomous driving according to one embodiment. System architecture 200 may represent system architecture of an autonomous driving system as shown in FIG. 1. Referring to FIG. 2, system architecture 200 includes, but it is not limited to, application layer 201, planning and control (PNC) layer 202, perception layer 203, driver layer 204, firmware layer 205, and hardware layer 206. Application layer 201 may include user interface or configuration application that interacts with users or passengers of an autonomous driving vehicle, such as, for example, functionalities associated with user interface system 113. PNC layer 202 may include functionalities of perception and planning system 110 and control system 111. Perception layer 203 may include functionalities of at least perception and planning system 110. Firmware layer 205 may represent at least the functionality of sensor system 115, which may be implemented in a form of a field programmable gate array (FPGA). Hardware layer 206 may represent the hardware of the autonomous driving vehicle such as control system 111. Layers 201-203 can communicate with firmware layer 205 and hardware layer 206 via device driver layer 204.

PNC layer 202 and perception 203 layer may run on neural networks whose models, such as algorithms and models 124, are generated by embodiments of the disclosure. The models may be generated offline by evaluating the sparsity levels of the channel kernels of a neural network to consolidate sparse channels for one or more layers and to retrain channel models based on the consolidated sparse channels to generate a modified channel model. The sparsity levels associated with the consolidated sparse channels of the modified channel model may be compared against sparsity inference thresholds to control the operations of the inference layers during operation of the neural networks.

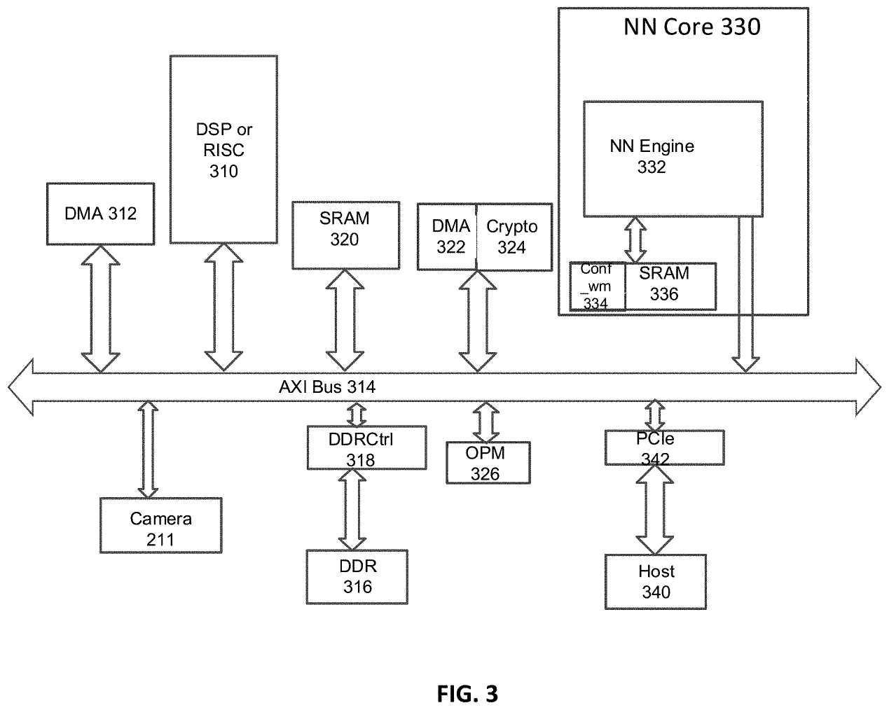

FIG. 3 is an architecture of a neural network (NN) core 330 in a host computing system in which NN models are downloaded into a SRAM of the NN core 330 from external memories according to one embodiment. The NN core 330 may be part of control system 111 or perception and planning system 110 of autonomous vehicle 101, and the host computing system may be a processor of autonomous vehicle 101 or servers 103-104.

NN core 330 includes NN engine 332 and NN SRAM 336. NN engine 332 runs the NN algorithms and models of the inference layers for one or more processes such as perception, prediction, decision, planning, or control of autonomous vehicle 101. NN engine 332 may access NN models stored in NN SRAM 336. NN SRAM 336 may have a portion of its memory (configured weight memory 334) partitioned to store a segment of model weights of the NN models or to store metadata of the NN models.

The host computing system includes DSP or RISC 310, and memories including DDR (double-data rate) memories 316 such as DDR DRAM, SRAM 320, and OPM (one-time programmable memory) 326. Due to the large size of the NN models, the NN models may be stored in DDR memories 316 externally to NN core 330 when NN core is offline. The NN models may be stored as executable loadable files (ELFs). DDR Control 318 module generates the control signals to access and refresh DDR memories 316.

The host computing system includes sensors from sensor system 115 such as camera 211. DMA module 312 allow camera 211 and other peripherals to have direct memory access (DMA) capability to DDR memories 316. A separate DMA module 322 provides DMA capability for NN core 330 to download NN models from DDR memories 316. A bus such as AXI (Advanced eXtensible Interface) bus 314 communicatively couples NN core 330, DSP or RISC 310, the memory subcomponents, and camera 211. An external host 340 may also communicate with the host computing system through an interface such as PCIe (peripheral component interconnect express) 342.

When NN core 330 is activated to run NN algorithms, DMA module 322 may download NN models from DDR memories 316 into NN SRAM 336. The NN models may be download as ELFs. Each ELF may contain the model weights, the metadata, and hash of the model weights and hash of the metadata for online verification. In one embodiment, the NN models may be copied first from DDR memories 316 into SRAM 320 external to NN core 330, and then from SRAM 320 to NN SRAM 336. To protect NN SRAM 336 against unauthorized access by the host computing system, external access to NN SRAM 336 is made only through cryptographic module 324. Cryptographic module 324 may verify NN models for successive inference layers until NN core 330 completes all the inference layers.

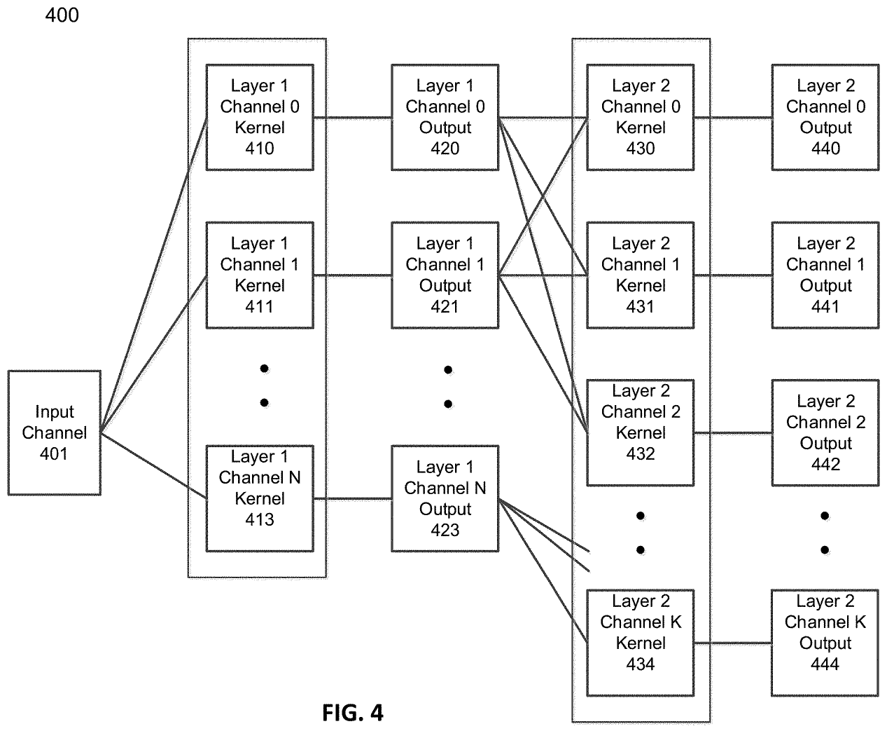

FIG. 4 shows a model of a neural network 400 with multiple inference layers and the channel kernels for the inference layers according to one embodiment. Neural network 400 may process input channel data 401 such as video and electromagnetic images captured by sensor system 115 of ADV 101 through one or more layers using the channel kernels to derive a feature map output. In one embodiment, neural network 400 may be a convolutional neural network (CNN) in which different elements of a channel input share a channel kernel to generate an output channel. In one embodiment, input channel data may be frames of video data in RGB.

Each layer of a neural network model may compute a representation of input channel data 401 from a previous layer to inference one or more output channels using the matrices or tensors of the channel kernels. For example, input channel 401 may be multiplied by channel 0 kernel 410, channel 1 kernel 411, . . . channel N kernel 413 of the first layer to generate first layer channel 0 output 420, channel 1 output 421, . . . channel N output 423, respectively. In the example of the RGB video data, each of channel 0 kernel 410, channel 1 kernel 411, . . . channel N kernel 413 may include three matrices that are respectively multiplied by the RGB data and summed to generate the corresponding output channels for the first layer.

To inference output channels for the second layer, one or more of output channels for the first layer may be multiplied by channel 0 kernel 430, channel 1 kernel 431, channel 2 kernel 432, . . . channel K kernel 434 of the second layer to generate second layer channel 0 output 440, channel 1 output 441, channel 2 output 442, . . . channel K output 444, respectively. Each of channel 0 kernel 430, channel 1 kernel 431, channel 2 kernel 432, . . . channel K kernel 434 of the second layer may include the same number of matrices as the number of output channels of the first layer used to inference an output channel for the second layer. The matrices of the channel kernels of the second layer are separately multiplied by the corresponding output channels of the first layer and summed to generate the corresponding output channels for the second layer. The number of output channels, N, for the first layer may be different than the number of output channels, K for the second layer. Neural network 400 may include additional inference layers and may be trained to generate the channel kernels for the different layers. The channel kernels may have different sparsity levels. To accelerate the inference operations, a method is disclosed to consolidate sparse channels for one or more layers and to retrain the consolidated channels to generate a modified neural network model.

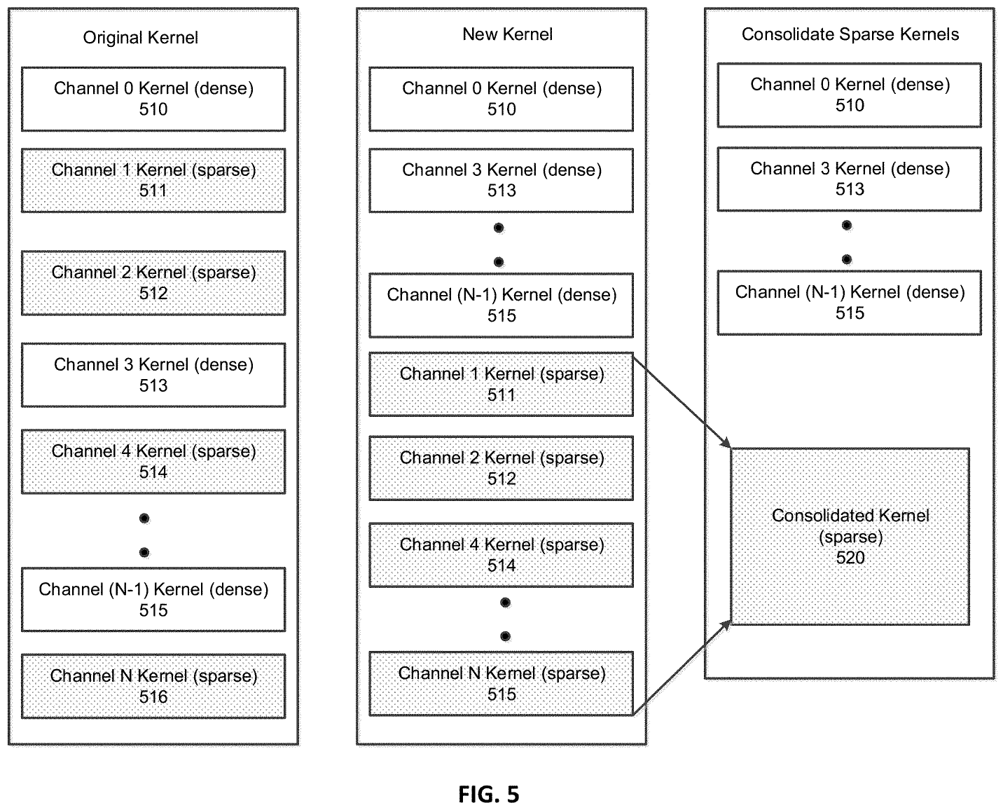

FIG. 5 illustrates an offline method of rearranging the channels for a layer according to the sparsity levels of the channel kernels and consolidating the sparse channels into one channel by concatenating the associated channel kernels when generating the modified neural network model according to one embodiment. In one embodiment, the method may determine the sparsity levels of the channel kernels by determining the number of non-zero elements in the matrices constituting each channel kernel. Channel kernels that have a high number of zeros and consequently a low sparsity level are sparse channels. In one embodiment, the sparsity level of a channel kernel may be determined by summing the absolute values of the elements in the matrices constituting the channel kernel and normalizing the summed value. By taking into account the values of the matrix elements rather than simply counting the number of non-zero matrix elements, channel kernels that have a high number of near-zero parameters in the matrices may also be considered as sparse channels. In one embodiment, the sparsity levels of the channel kernels are compared against a threshold to determine if the corresponding channels are considered dense or sparse. If the sparsity level of a channel kernel is higher than the threshold, the corresponding channel is considered a dense channel. Otherwise, the channel is sparse.

FIG. 5 illustrates that channel kernels for channels 0 (510), channel 3 (513), and channel N−1 (515) among others correspond to channels that are considered dense channels; channel kernels for channels 1 (511), channel 2 (512), channel 4 (514), and channel N (516) among others correspond to channels that are considered sparse channels. In one embodiment, the method may rearrange the channels in accordance with the sparsity levels of their corresponding channel kernels to group separately the dense channels from the sparse channels. For example, channel kernels for channel 3 (513) and channel N−1 (515) are rearranged along with those of other dense channels to group together all the dense channels. Channel kernels for channel 1 (511), channel 2 (512), and channel 4 (514) are rearranged along with those of other sparse channels to group together all the sparse channels. In one embodiment, the method may rearrange the channels by re-indexing the channels or the corresponding channel kernels.

The method may consolidate the sparse channels into one channel by concatenating the channel kernels of the sparse channels into a consolidated channel kernel 520. Rearranging the channels to group together all the sparse channels may facilitate the consolidation of the sparse channels. However, the method is not so limited as the sparse channels may be consolidated without being rearranged. In one embodiment, concatenating the channel kernels of the sparse channels to yield consolidated channel kernel 520 may include summing the matrix elements having the same matrix indices from the channel kernels of the sparse channels. Consolidation of sparse channels may be performed for every layer or for the first few layers of the neural network model.

After consolidating the sparse channels, the method may retrain consolidated channel kernel 520 while keeping fixed the channel kernels for the dense channels to generate a modified neural network model. For example, the method may disable back propagation for the dense channels and may back propagate errors only from the consolidated sparse channel to adjust the matrix elements of consolidated channel kernel 520 during retraining until the neural network model meets certain training-error requirement. After retraining, the method may quantize the channel kernels of the dense channels and consolidated channel kernel 520 of the consolidated sparse channel to generate the modified neural network model for inference.

The sparsity level of consolidated channel kernel 520 may change during retraining so that the consolidated sparse channel may remain sparse or may become a dense channel. The method may determine the sparsity level of consolidated channel kernel 520 after retraining and may store the sparsity level into metadata of the modified neural network model. In one embodiment, the method may store a sparse channel flag associated with the consolidated sparse channel into metadata to differentiate the consolidated sparse channel from the dense channels whose channel kernels stayed fixed during the retraining. In one embodiment, the method may also store the sparsity levels of the channel kernels for the dense channels into metadata. To reduce the memory requirement for storing the channel kernels of the sparse channels or the consolidated sparse channel, the method may store the non-zero elements of the channel kernels in compressed sparse row (CSR) or compressed sparse column (CSC) formats.

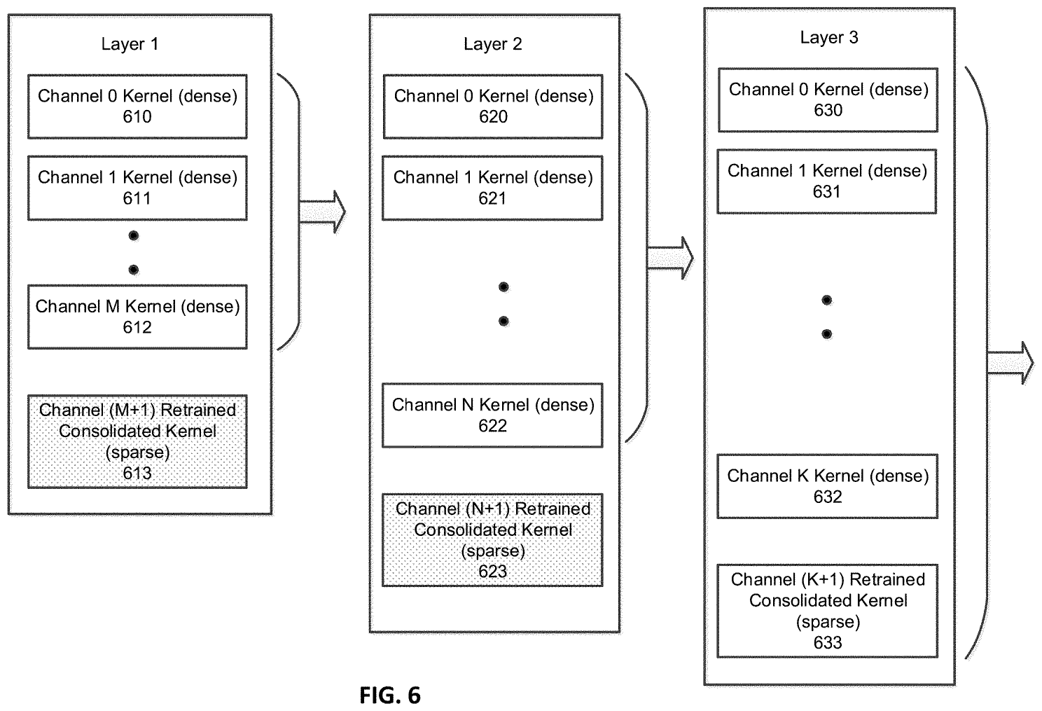

FIG. 6 illustrates an arrangement of the channels for multiple inference layers of a retrained neural network model after the sparse channels for each layer are consolidated into one channel according to one embodiment of the offline model generation method. Layer 1 includes channel kernels for channel 0 (610), channel 1 (611), . . . channel M (612) of the dense channels and channel kernel for channel (M+1) 613 of the consolidated sparse channel that has been retrained.

The method may control the inferencing operations for layer 1 based on the sparsity level of the channel kernel for the consolidated sparse channel. For example, the method may read the sparsity level of channel kernel for channel (M+1) 613 from metadata and may compare the sparsity level against a sparsity inference threshold to determine whether to inference the consolidated sparse channel. If the sparsity level associated with channel (M+1) 613 is greater than the sparsity inference threshold, the method may inference the consolidated sparse channel for layer 1. Otherwise, the method does not inference the consolidated sparse channel. If the decision as to whether to inference a channel is only made for the consolidated sparse channel, the method may identify the consolidated sparse channel and its associated sparsity level by the sparse channel flag read from metadata.

In one embodiment, the method may also compare the sparsity levels of channel kernels for dense channel 0 (610), channel 1 (611), . . . channel M (612) against the sparsity inference threshold to determine whether to inference the dense channels. The sparsity inference threshold may be set lower than the threshold used to determine during offline model training whether a channel is a dense channel so all the dense channels are inferenced. FIG. 6 illustrates that the sparsity levels associated with the dense channels for layer 1 are all greater than the sparsity inference threshold, but the sparsity level associated with channel (M+1) 613 is less than the sparsity inference threshold. Therefore, for layer 1, all the dense channels are inferenced, but the consolidated sparse channel is not inferenced.

In one embodiment, the sparsity inference threshold may be dynamically adjusted online or offline to strike a balance between speed and accuracy of the inference operations of the neural network model. For example, if the accuracy of the feature map output from the neural network model is less than a required accuracy, the method may lower the sparsity inference threshold to enable the inferencing operation for the consolidated sparse channel at the cost of decreased throughput of the neural network model. On the other hand, if the consolidated sparse channel is inferenced, but the speed of the neural network model is less than a required speed, the method may raise the sparsity inference threshold to disable the inferencing operation for the consolidated sparse channel at a cost of decreased accuracy.

Layer 2 includes channel kernels for channel 0 (620), channel 1 (621), . . . channel N (622) of the dense channels and channel kernel for channel (N+1) 623 of the consolidated sparse channel that has been retrained. For layer 2, the method may similarly compare the sparsity level of channel kernel for channel (N+1) 623 against a sparsity inference threshold for layer 2 to determine whether to inference the consolidated sparse channel. In one embodiment, the method may similarly compare the sparsity levels of channel kernels for dense channel 0 (620), channel 1 (621), . . . channel N (622) against the sparsity inference threshold to determine whether to inference the dense channels. The sparsity inference thresholds for the different layers may be different to provide the flexibility to fine tune the inferencing operations of each layer. FIG. 6 illustrates that the sparsity levels associated with the dense channels for layer 2 are greater than the sparsity inference threshold, but the sparsity level associated with channel (N+1) 623 is less than the sparsity inference threshold. Therefore, for layer 2, all the dense channels are inferenced, but the consolidated sparse channel is not inferenced, as in layer 1.

Layer 3 includes channel kernels for channel 0 (630), channel 1 (631), . . . channel K (632) of the dense channels and channel kernel for channel (K+1) 633 of the consolidated sparse channel that has been retrained. For layer 3, the method may compare the sparsity level of channel kernel for channel (K+1) 633 against a sparsity inference threshold for layer 3 to determine whether to inference the consolidated sparse channel. In one embodiment, the method may compare the sparsity levels of channel kernels for dense channel 0 (630), channel 1 (631), . . . channel K (632) against the sparsity inference threshold to determine whether to inference the dense channels. FIG. 6 illustrates that the sparsity levels associated with the dense channels for layer 3 as well as that associated with channel (K+1) 633 are all greater than the sparsity inference threshold. Therefore, for layer 3, all the channels including the consolidated sparse channel are inferenced.

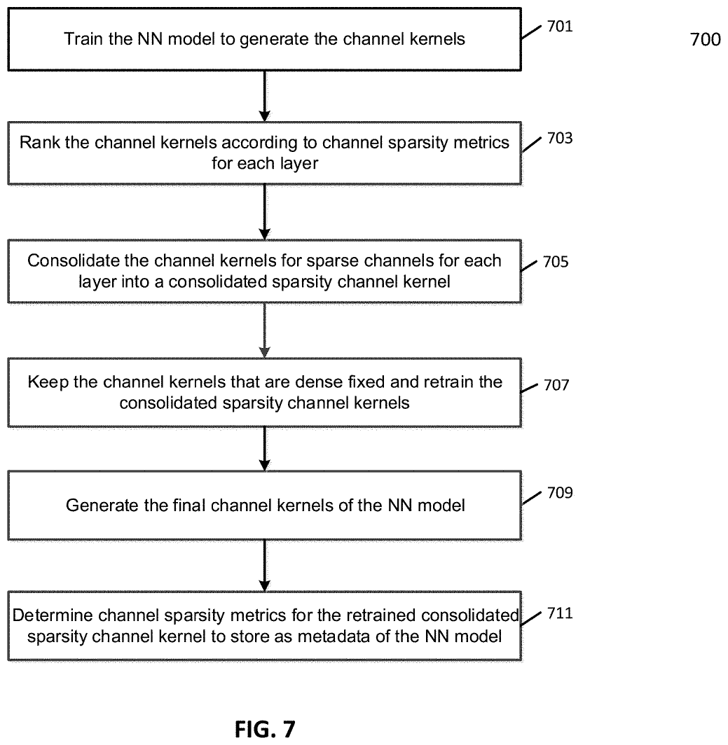

FIG. 7 is a flowchart illustrating a method 700 for offline training and generation of a neural network model that consolidates the sparse channels for a layer into one channel according to one embodiment. Method 700 may be performed by processing logic which may include software, hardware, or a combination thereof. For example, method 700 may be performed by DSP or RISC 310, or external host 340. The neural network model may be a convolutional neural network or model 400 of FIG. 4.

At operation 701, the method 700 trains the neural network model to generate the channel kernels for the different layers of the model. The channel kernels may have different sparsity levels.

At operation 703, the method 700 ranks the channel kernels according to channel sparsity metrics for each layer. In one embodiment, the method 700 may determine the sparsity levels of the channel kernels by determining the number of non-zero elements in the matrices constituting each channel kernel. In one embodiment, the sparsity levels of the channel kernels may be determined by summing the absolute values of the elements in the matrices constituting the channel kernels and normalizing the summed value. In one embodiment, the sparsity levels of the channel kernels are compared against a threshold to determine if the corresponding channels are considered dense or sparse. If the sparsity level of a channel kernel is higher than the threshold, the corresponding channel is considered a dense channel. Otherwise, the channel is sparse. In one embodiment, the method 700 may rearrange the channels in accordance with the sparsity levels of their corresponding channel kernels to group separately the dense channels from the sparse channels.

At operation 705, the method 700 consolidates the sparse channels into one channel by concatenating the channel kernels of the sparse channels into a consolidated channel kernel. For example, the method 700 may sum the matrix elements having the same matrix indices from the channel kernels of the sparse channels to generate the consolidated channel kernel. Consolidation of sparse channels may be performed for every layer or for the first few layers of the neural network model.

At operation 705, the method 700 retrains the consolidated channel kernel while keeping fixed the channel kernels for the dense channels to generate a modified neural network model. For example, the method 700 may disable back propagation for the dense channels and may back propagate errors only from the consolidated sparse channel to adjust the matrix elements of the consolidated channel kernel during retraining until the neural network model meets certain training-error requirement.

At operation 707, the method 700 generates the final channel kernels of the neural network model. For example, the method 700 may quantize the channel kernels of the dense channels and the consolidated channel kernel of the consolidated sparse channel.

At operation 709, the method 700 determines the channel sparsity metrics for the consolidated channel kernel that has been retrained and stores the channel sparsity metrics into the metadata of the neural network model. The channel sparsity metrics for the consolidated channel kernel may have changed during the retraining so that the consolidated sparse channel may remain sparse or may become a dense channel. In one embodiment, the method 700 may store a sparse channel flag associated with the consolidated sparse channel into the metadata to differentiate the consolidated sparse channel from the dense channels. In one embodiment, the method 700 may also store the channel sparsity metrics of the channel kernels for the dense channels into the metadata.

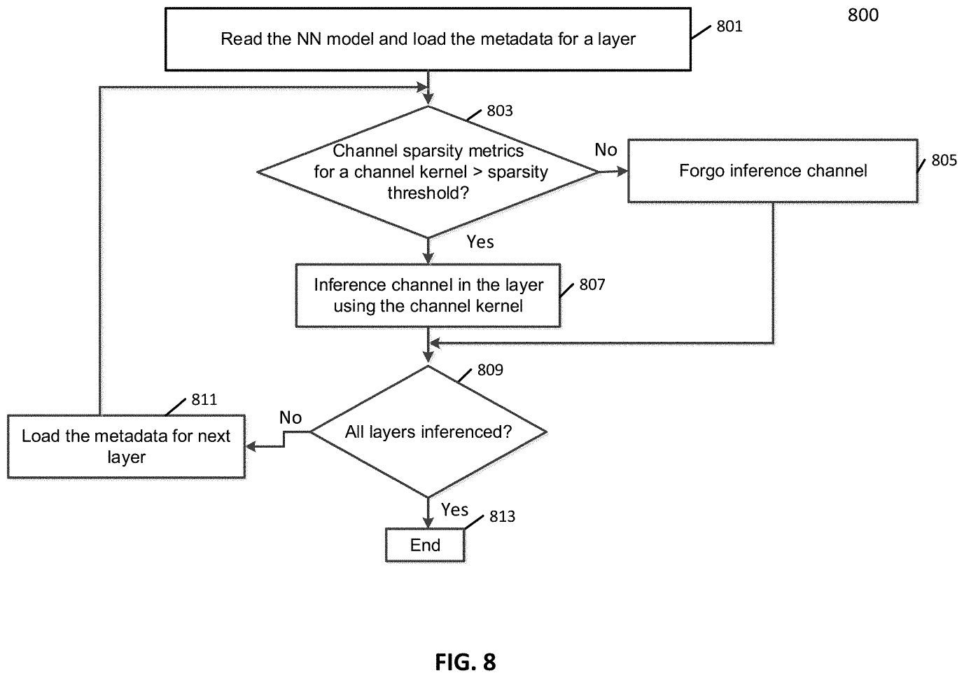

FIG. 8 is a flowchart illustrating a method 800 of controlling online inference operations based on sparsity metrics of the channel kernels of the neural network model that includes a consolidated sparse channel according to one embodiment. Method 800 may be performed by processing logic which may include software, hardware, or a combination thereof. For example, method 800 may be performed by neural network engine 332. The neural network model may be a convolutional neural network or model 400 of FIG. 4.

At operation 801, the method 800 reads the neural network model and loads the metadata for a layer. For example, the method 800 may load the metadata for a layer containing the channel sparsity metrics of the channel kernels for the consolidated sparse channel and the dense channels of the layer from DDR 316 into SRAM 336 of neural network core 330.

At operation 803, the method 800 compares the channel sparsity metrics of the channel kernel of a channel against a sparsity inference threshold to determine whether to inference the channel. In one embodiment, the method 800 may compare the channel sparsity metrics of the consolidated channel kernel of the consolidated sparse channel against the sparsity inference threshold for the layer. In one embodiment, if only the channel sparsity metrics associated with the consolidated sparse channel is compared against the sparsity inference threshold for the layer, the method 800 may identify the consolidated sparse channel and its associated sparsity level by the sparse channel flag read from the metadata. In one embodiment, the method 800 may compare the channel sparsity metrics of the channel kernels for the dense channels against the sparsity inference threshold to determine whether to inference the dense channels. In one embodiment, the sparsity inference threshold may be dynamically adjusted to strike a balance between speed and accuracy of the inference operations of the neural network model

At operation 805, if the channel sparsity metrics of the channel kernel for the channel is less than or equal to the sparsity inference threshold for the layer, the method 800 does not inference the channel. For example, if the channel sparsity metrics associated with the consolidated sparse channel is less than the sparsity inference threshold, inference for the consolidated sparse channel is not performed.

At operation 807, if the channel sparsity metrics of the channel kernel for the channel is greater than the sparsity inference threshold for the layer, the method 800 inferences the channel. For example, if the channel sparsity metrics associated with the consolidated sparse channel is greater than the sparsity inference threshold, the consolidated channel kernel may be loaded into neural network core 300. The consolidated channel kernel may be multiplied by the input channel of the layer to inference the channel output for the consolidated sparse channel.

At operation 809, the method 800 determines if all layers of the neural network model have been inferenced. If all the layers have been inferenced, the method 800 terminates at operation 813.

At operation 811, if there is at least one more layer to inference, the method loads the metadata for the next layer. Operations 803, 805, and 807 may be repeated to control inference operations based on the channel sparsity metrics of the channel kernels for the next layer that includes a consolidated sparse channel. In one embodiment, inference operations may be controlled for every layer of the neural network model. In one embodiment, inference operations may be controlled for only the first few layers of the neural network model and operations 803, 805, and 807 may be repeated only for these few layers.

A data processing system may perform any of the processes or methods described above, such as, for example, the offline training and generation of the neural network model that consolidates the sparse channels for a layer into one channel, or controlling online inference operations based on the sparsity metrics of the channel kernels of the consolidated sparse channel. The data processing system can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

The data processing system may include one or more processors, one or more memories, and devices connected via a bus. Processors may represent one or more general-purpose processors such as a microprocessor, a central processing unit (CPU), or the like. More particularly, processors may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processors may also be one or more special-purpose processors such as an application specific integrated circuit (ASIC), a cellular or baseband processor, a field programmable gate array (FPGA), a digital signal processor (DSP), a network processor, a graphics processor, a communications processor, a cryptographic processor, a co-processor, an embedded processor, or any other type of logic capable of processing instructions. Processors may be configured to execute instructions stored in the memories for performing the operations and steps discussed herein.

Processing module/unit/logic, components and other features described herein can be implemented as discrete hardware components or integrated in the functionality of hardware components such as ASICS, FPGAs, DSPs or similar devices. In addition, processing module/unit/logic can be implemented as firmware or functional circuitry within hardware devices. Further, processing module/unit/logic can be implemented in any combination hardware devices and software components.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilising terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method for operating inference layers of a neural network (NN) model, the method comprising:
reading metadata of an inference layer of the NN model, the inference layer including a plurality of channels, and the metadata including channel sparsity metrics of a plurality of channel kernels corresponding to the plurality of channels;
comparing the channel sparsity metrics of the channel kernel corresponding to one channel of the plurality of channels against a sparsity inference threshold; and
controlling inference operations of the one channel in response to determining that the channel sparsity metrics of the channel kernel corresponding to the one channel is greater than the sparsity inference threshold.

2. The method of claim 1, wherein controlling inference operations of the one channel comprises:
enabling the inference operations in response to determining that the channel sparsity metrics of the channel kernel corresponding to the one channel is greater than the sparsity inference threshold; or
disabling the inference operations in response to determining that the channel sparsity metrics of the channel kernel corresponding to the one channel is less than or equal to the sparsity inference threshold.

3. The method of claim 1, wherein the sparsity inference threshold is dynamically adjusted in accordance with a required speed or accuracy of the inference operations.

4. The method of claim 1, further comprising:
reading metadata of an additional inference layer of the NN model; and
comparing channel sparsity metrics of a channel kernel corresponding to one channel of the additional inference layer against a second sparsity inference threshold; and
controlling inference operations of the one channel of the additional inference layer in response to determining that the channel sparsity metrics of the channel kernel corresponding to the one channel of the additional inference layer is greater than the second sparsity inference threshold.

5. The method of claim 1, further comprising:
training the NN model to generate a plurality of original channel kernels corresponding to a plurality of original channels of the inference layer;
ranking the plurality of original channel kernels of the inference layer according to channel sparsity metrics of the plurality of original channel kernels to determine whether the corresponding original channels of the inference layer are a dense channel or a sparse channel;
consolidating all of the sparse channels of the inference layer into a consolidated sparse channel to generate a consolidated channel kernel; and
retraining the consolidated channel kernel to generate a retrained consolidated channel kernel corresponding to the consolidated sparse channel while keeping fixed the original channel kernels corresponding to all of the dense channels of the inference layer.

6. The method of claim 5, further comprising:
generating the plurality of channels of the inference layer as including all of the dense channels and the consolidated sparse channel of the inference layer;
determining channel sparsity metrics of the retrained consolidated channel kernel; and
storing the channel sparsity metrics of the retrained consolidated channel kernel corresponding to the consolidated sparse channel and the channel sparsity metrics of the original channel kernels corresponding to all of the dense channels of the inference layer into the metadata.

7. The method of claim 6, wherein comparing the channel sparsity metrics of the channel kernel corresponding to the one channel of the plurality of channels against a sparsity inference threshold comprises:
comparing the channel sparsity metrics of the retrained consolidated channel kernel corresponding to the consolidated sparse channel against the sparsity inference threshold.

8. The method of claim 6, further comprising:
comparing the channel sparsity metrics of the original channel kernel corresponding to one channel of the dense channels of the inference layer against the sparsity inference threshold; and
controlling inference operations of the one channel of the dense channels of the inference layer in response to determining that the channel sparsity metrics of the original channel kernel corresponding to the one channel of the dense channels is greater than the sparsity inference threshold.

9. The method of claim 6, wherein ranking the plurality of original channel kernels of the inference layer according to channel sparsity metrics of the plurality of original channel kernels to determine whether the corresponding original channels of the inference layer are a dense channel or a sparse channel comprises:
rearranging the plurality of original channels of the inference layer to group separately all of the dense channels and all of the sparse channels.

10. The method of claim 6, wherein consolidating all of the sparse channels of the inference layer into the consolidated sparse channel to generate the consolidated channel kernel comprises:
concatenating the plurality of original channel kernels corresponding to all of the sparse channels of the inference layer to generate the consolidated channel kernel.

11. A data processing system, comprising:
a processor;
a memory coupled to the processor to store instructions, which when executed by the processor, cause the processor to perform operations, the operations comprising:
reading metadata of an inference layer of a neural network (NN) model, the inference layer including a plurality of channels, and the metadata including channel sparsity metrics of a plurality of channel kernels corresponding to the plurality of channels;
comparing the channel sparsity metrics of the channel kernel corresponding to one channel of the plurality of channels against a sparsity inference threshold; and
controlling inference operations of the one channel in response to determining that the channel sparsity metrics of the channel kernel corresponding to the one channel is greater than the sparsity inference threshold.

12. The data processing system of claim 11, wherein controlling inference operations of the one channel comprises:
enabling the inference operations in response to determining that the channel sparsity metrics of the channel kernel corresponding to the one channel is greater than the sparsity inference threshold; or
disabling the inference operations in response to determining that the channel sparsity metrics of the channel kernel corresponding to the one channel is less than or equal to the sparsity inference threshold.

13. The data processing system of claim 11, wherein the sparsity inference threshold is dynamically adjusted in accordance with a required speed or accuracy of the inference operations.

14. The data processing system of claim 11, wherein the operations further comprise:
reading metadata of an additional inference layer of the NN model; and
comparing channel sparsity metrics of a channel kernel corresponding to one channel of the additional inference layer against a second sparsity inference threshold; and
controlling inference operations of the one channel of the additional inference layer in response to determining that the channel sparsity metrics of the channel kernel corresponding to the one channel of the additional inference layer is greater than the second sparsity inference threshold.

15. The data processing system of 11, wherein the operations further comprise:
training the NN model to generate a plurality of original channel kernels corresponding to a plurality of original channels of the inference layer;
ranking the plurality of original channel kernels of the inference layer according to channel sparsity metrics of the plurality of original channel kernels to determine whether the corresponding original channels of the inference layer are a dense channel or a sparse channel;
consolidating all of the sparse channels of the inference layer into a consolidated sparse channel to generate a consolidated channel kernel; and
retraining the consolidated channel kernel to generate a retrained consolidated channel kernel corresponding to the consolidated sparse channel while keeping fixed the original channel kernels corresponding to all of the dense channels of the inference layer.

16. The data processing system of 16, wherein the operations further comprise:
generating the plurality of channels of the inference layer as including all of the dense channels and the consolidated sparse channel of the inference layer;
determining channel sparsity metrics of the retrained consolidated channel kernel; and
storing the channel sparsity metrics of the retrained consolidated channel kernel corresponding to the consolidated sparse channel and the channel sparsity metrics of the original channel kernels corresponding to all of the dense channels of the inference layer into the metadata.

17. The data processing system of 16, wherein comparing the channel sparsity metrics of the channel kernel corresponding to the one channel of the plurality of channels against a sparsity inference threshold comprises:
comparing the channel sparsity metrics of the retrained consolidated channel kernel corresponding to the consolidated sparse channel against the sparsity inference threshold.

18. The data processing system of claim 16, wherein the operations further comprise:
comparing the channel sparsity metrics of the original channel kernel corresponding to one channel of the dense channels of the inference layer against the sparsity inference threshold; and
controlling inference operations of the one channel of the dense channels of the inference layer in response to determining that the channel sparsity metrics of the original channel kernel corresponding to the one channel of the dense channels is greater than the sparsity inference threshold.

19. The data processing system of claim 16, wherein ranking the plurality of original channel kernels of the inference layer according to channel sparsity metrics of the plurality of original channel kernels to determine whether the corresponding original channels of the inference layer are a dense channel or a sparse channel comprises:
rearranging the plurality of original channels of the inference layer to group separately all of the dense channels and all of the sparse channels.

20. The data processing system of claim 16, wherein consolidating all of the sparse channels of the inference layer into the consolidated sparse channel to generate the consolidated channel kernel comprises:
concatenating the plurality of original channel kernels corresponding to all of the sparse channels of the inference layer to generate the consolidated channel kernel.

21. A non-transitory machine-readable medium having instructions stored therein, which when executed by a processor, cause the processor to perform operations of inference layers of a neural network (NN) model, the operations comprising:
reading metadata of an inference layer of the NN model, the inference layer including a plurality of channels, and the metadata including channel sparsity metrics of a plurality of channel kernels corresponding to the plurality of channels;
comparing the channel sparsity metrics of the channel kernel corresponding to one channel of the plurality of channels against a sparsity inference threshold; and
controlling inference operations of the one channel in response to determining that the channel sparsity metrics of the channel kernel corresponding to the one channel is greater than the sparsity inference threshold.

22. The non-transitory machine-readable medium of claim 21, wherein the operations further comprise:
training the NN model to generate a plurality of original channel kernels corresponding to a plurality of original channels of the inference layer;
ranking the plurality of original channel kernels of the inference layer according to channel sparsity metrics of the plurality of original channel kernels to determine whether the corresponding original channels of the inference layer are a dense channel or a sparse channel;
consolidating all of the sparse channels of the inference layer into a consolidated sparse channel to generate a consolidated channel kernel;
retraining the consolidated channel kernel to generate a retrained consolidated channel kernel corresponding to the consolidated sparse channel while keeping fixed the original channel kernels corresponding to all of the dense channels of the inference layer;
generating the plurality of channels of the inference layer as including all of the dense channels and the consolidated sparse channel of the inference layer;
determining channel sparsity metrics of the retrained consolidated channel kernel; and
storing the channel sparsity metrics of the retrained consolidated channel kernel corresponding to the consolidated sparse channel and the channel sparsity metrics of the original channel kernels corresponding to all of the dense channels of the inference layer into the metadata.
